(19) United States
(12) Patent Application Publication
(10) Pub. No.: US 2002/0123896 A1
(43) Pub. Date: Sep. 5, 2002

(54) Control module for HVAC systems

(76) Inventors: Tomas Diez, Avon, IN (US); Mary Jo Dunn, Avon, CT (US); H. Ezzat Khalifa, Manlius, NY (US); Christian Netter, Tolland, CT (US); Timothy M. Remmers, New Hartford, CT (US); William Weiss, Glastunbury, CT (US); Felipe Costa, Sao Leopoldo - RS (BR); Carlos Rodrigues, Porto Alegre - RS (BR); Michael Tedone, Windsor Locks, CT (US); Thomas Hamilton, South Windsor, CT (US)

Correspondence Address: GEORGE A. COURY, BACHMAN & LaPOINTE, P.C., Suite 1201, 900 Chapel Street, New Haven, CT, 06510-2802, US

(21) Appl. No.: 10/082,874

(22) Filed: Feb. 26, 2002

Related U.S. Application Data
(60) Provisional application No. 60/272,188, filed on Feb. 28, 2001.

(51) Int. Cl. G10L 11/00

(52) U.S. Cl. 704/275

(57) ABSTRACT

A control system for a heating, ventilating or air conditioning HVAC system includes a remote command receiver for receiving HVAC system instructions for the HVAC system; and conditioning HVAC system, including a remote command receiver for receiving HVAC system instructions for the HVAC system; and a control module, including (i) a speech receiving member for receiving speech commands; and (ii) a converter for converting the speech commands to HVAC system instructions; wherein the module is communicated with the receiver for conveying the HVAC system instructions from the module to the receiver.

### CROSS REFERENCE TO RELATED APPLICATION

This application claims the benefit of U.S. Provisional Application Serial No. 60/272,188, Filed Feb. 28, 2001.

### BACKGROUND OF THE INVENTION

The invention relates to speech recognition-based control for HVAC systems such as window air conditioners and the like.

Heating, ventilating and air conditioning (HVAC) systems are routinely used to control various environments. In many instances, it is desirable to be able to control such systems without having to manually enter specific instructions. Further, it is frequently difficult for persons who have lost mobility or manual dexterity to control an HVAC system using conventional controls.

Speech recognition technology is rapidly advancing, and low cost computer speech recognition systems now exist as artificial neural networks on computer chips. Such chips are available at low cost, and can be used in relatively quiet environments, for example, where acoustic measurements are generally less than about 60 dB A, to issue commands to electronic devices.

Unfortunately, such speech recognition systems can be interfered with in noisy environments, for example where acoustic measurements are generally greater than about 60 dB A, which are frequently encountered in the vicinity of HVAC systems in operation.

The need remains for improved control of HVAC systems such as window air conditioners.

It is therefore the primary object of the present invention to provide a control system for an HVAC system which facilitates control of same.

Other objects and advantages of the present invention will appear hereinbelow.

### SUMMARY OF THE INVENTION

In accordance with the present invention, the foregoing objects and advantages have been readily attained.

According to the invention, a control system is provided for a heating, ventilating or air conditioning (HVAC) system, which control system comprises a remote command receiver for receiving HVAC system instructions for said HVAC system; and a control module, comprising (i) a speech receiving member for receiving speech commands; and (ii) a converter for converting said speech commands to HVAC system instructions; wherein said module is communicated with said receiver for conveying said HVAC system instructions from said module to said receiver.

In accordance with a further aspect of the present invention, a control module for controlling a heating, ventilating or air conditioning (HVAC) system is provided, which comprises a speech receiving member for receiving speech commands; a converter for converting said speech commands to HVAC system instructions; and a transmitter for transmitting said HVAC system instructions to said HVAC system.

### BRIEF DESCRIPTION OF THE DRAWINGS

A detailed description of preferred embodiments of the present invention follows, with reference to the attached drawings, wherein:

FIG. 1 schematically illustrates a system and control module in accordance with the present invention;

FIG. 2 illustrates a preferred embodiment of a control module in an environment of use; and

FIG. 3 is a flow chart illustrating operation of the control module of the invention.

### DETAILED DESCRIPTION

The invention relates to a control system for controlling heating, ventilating and air conditioning (HVAC) systems, which utilizes speech recognition so as to provide more versatile and convenient control of such HVAC systems. The system of the present invention is particularly applicable for use with window air conditioners (WRAC), as well as numerous other HVAC systems.

Conventionally, speech recognition technology has not been useful in connection with devices such as HVAC systems and the like which generate substantial amounts of noise, since the noise interferes with accurate operation of the speech recognition technology.

In accordance with the present invention, however, speech recognition capability is incorporated into a control module for the HVAC system such that speech commands are received and recognized at a point which is removed from the HVAC system, thereby avoiding the difficulties caused by sound generated by the HVAC system.

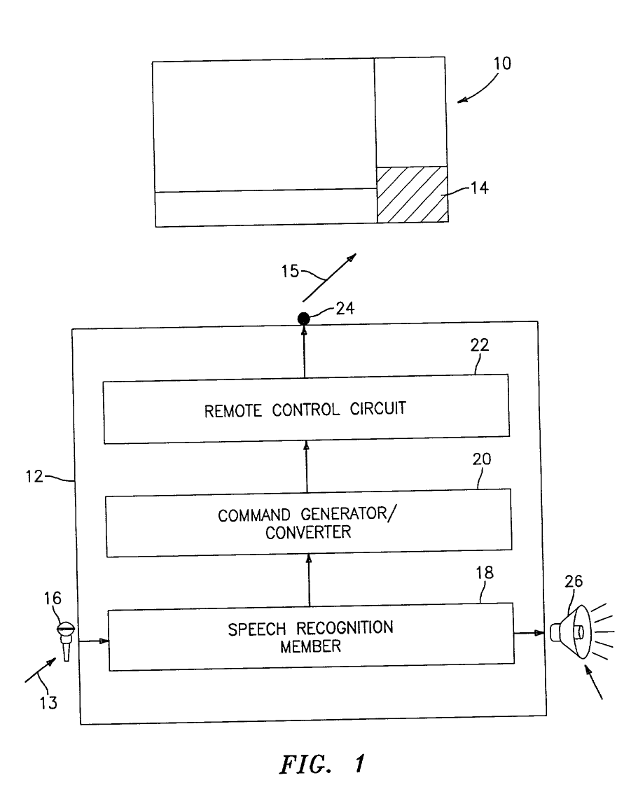

FIG. 1 schematically illustrates a system in accordance with the present invention.

As shown, an HVAC system such as a window air conditioner 10 is advantageously controlled according to the invention using a control module 12. Control module 12 receives and recognizes speech commands 13 and prepares and issues HVAC system instructions 15 to HVAC system 10.

Control module 12 can advantageously be positioned at a location remote from HVAC system 10, but communicated with system 10, such that speech commands can be used to control system 10 as desired.

According to the invention, HVAC system 10 is advantageously provided with a remote command receiver 14 which is adapted to receive HVAC system instructions, preferably wireless transmitted instructions such as light-based instructions, radio instructions, and the like, from control module 12, and to operate system 10 in accordance with such received HVAC system instructions.

In accordance with the invention, control module 12 advantageously includes a speech receiving member 16 such as a microphone, which can be internal or external, and which is preferably a multi or omni-directional microphone such that control module 12 can receive speech commands from different locations in a room or other environment of use. Receiving member 16 is positioned on module 12 for effectively receiving speech commands, for example in a location which is not obstructed by module housing components or the like.

As shown, module 12 advantageously includes a speech recognition member 18 which may advantageously be a speech recognition neural network chip and software which are well known to a person of ordinary skill in the art. As shown, module 12 preferably further includes a command generator 20 which advantageously serves to convert words or speech received and recognized by module 12 into instructions for generating a suitable transmission containing the desired control commands for system 10. Instructions from command generator 20 are then advantageously conveyed to remote control circuit 22, which is adapted to generate commands for issuing the desired HVAC system instructions. Circuit 22 may be adapted to emulate switch closures, for example using multi-plexers, to perform the equivalent of electronically pressing buttons on a matrix of membrane switch contacts on a PC board or the like, for sequencing a transmitter of instructions such as an infrared light emitting diode (LED) transmitter 24, which is positioned to transmit to system 10 such that receiver 14 receives instructions issued by transmitter 24 as desired. Of course, circuit 22 could be adapted to issue commands to transmitter 24 in other ways as well, which would be readily known to a person of ordinary skill in the art.

In accordance with a preferred embodiment of the present invention, module 12 is also provided with an indicator for acknowledging commands. In one aspect of the present invention, the indicator may be a speech simulator member, for example including a speaker 26 and a signal generator such as a speech synthesizing response generator or plurality of pre-recorded words, phrases or other responses which can be associate with suitable programming for selecting a proper response. In this way, module 12 can advantageously be adapted to respond to or acknowledge speech commands received by microphone 16 and recognized by speech recognition member 18. The response or acknowledgement is any pre-programmed speech response, for example an identification of the command received or a prompt for more speech commands.

Module 12 may advantageously be utilized to control system 10 in accordance with the present invention as follows. A user speaks a command word in the vicinity of microphone 16, and microphone 16 detects the sound pressure waves from the user's voice. In accordance with this embodiment of the invention, the microphone is advantageously adapted to convert the sound pressure waves to voltages, and transmits these voltages to speech recognition member 18. Speech recognition member 18 is adapted to digitize the command signal represented by the voltages, and to determine whether the command spoken into microphone 16 is a recognized command. In this regard, speech recognition member 18 preferably includes a storage member for storing known speech patterns and corresponding instructions.

Speech recognition member 18 may advantageously be adapted to generate one or more words, preferably in ASCII text or any other suitable form, which represent the received speech command, and these word(s) are then transmitted to command generator 20.

Command generator 20 is preferably adapted to analyze the word or words it receives to determine whether the word or word string can be parsed into a complete command for system 10. In this regard, command generator 20 may advantageously also be provided with a storage member, or may share a storage member with speech recognition member 18, for storing information sufficient to identify complete commands when received.

Upon receipt of a complete command at command generator 20, command generator 20 advantageously converts the command to instructions for transmitting a signal, for example by emulating switch closures, for example by using multi-plexers to perform the equivalent of electronically pressing buttons on a matrix of membrane switch contacts on a PC board. Such a matrix of membrane switch contacts on a PC board, and emulation of switch closure of same, is known to a person of ordinary skill in the art and is a component of remote control circuit 22. Of course, other conversion or encoding techniques may be used.

In accordance with a preferred aspect of the present invention, wherein module 12 is provided with a speaker 26 and wherein speech recognition member 18 has speech generating capability, module 12 is adapted to generate an indicator, preferably a speech response, which replies to or otherwise acknowledges the speech commands received at microphone 16. In this way, a user can advantageously be assured that commands have been received and understood. Of course, although a speech response is preferred, the indicator could also be any other detectable condition such as a light, or an audible tone, and the like, as well as combinations of such indicators.

As shown, remote control circuit 22 in this embodiment is connected to an infrared LED transmitter 24. LED transmitter 24 is-advantageously positioned on module 12 so as to facilitate communication of infrared signals to HVAC system 10.

The user positions, or has previously positioned, control module 12 such that signals from LED 24 are received by the system to be controlled, and a signal or signal sequence is conveyed from module 12 to receiver 14 for controlling system 10 in accordance with the present invention.

It should readily be appreciated that module 12 in accordance with the present invention allows a user to control an HVAC system utilizing speech commands only, without the need to manipulate potentially difficult controls and without needing sufficient mobility to approach system 10. Further, the system of the present invention reduces or avoids complications caused by noise generated by the system.

In accordance with a further aspect of the invention, the neural network chip forming speech recognition member 18 allows for module 12 to be trained, if necessary, so as to correlate various personalized speech patterns of a particular user to various HVAC system commands whereby a module 12 in accordance with the present invention can be adapted to the speech and needs of individual users.

Although this disclosure is given in terms of infrared signals, it should readily be appreciated that other signals such as radio or other light-based signals could be used in complete accordance with the present invention. Further, it is within the broad scope of the present invention to communicate module 12 with system 10 in any known manner, including conventional wiring. Wireless communication is preferred, however, so as to allow the user greater versatility in positioning of module 12. It is further preferred to communicate module 12 and system 10 using light-based signals and/or radio signals, and of currently available technology, infrared communications are particularly suitable.

Further, although this example is given in terms of a window air conditioner, which is certainly an advantageous environment of use, the system and module of the present invention can be used to enhance control options for other types of HVAC systems as well, such as heaters, air filtering equipment, ventilation systems, refrigeration systems and the like.

Speech recognition member 18 may advantageously be adapted so as to repeat recognized speech commands received at microphone 16, and/or may further be adapted to prompt the user that a command is complete/incomplete, and further as to what additional type of information is needed to complete the incomplete command.

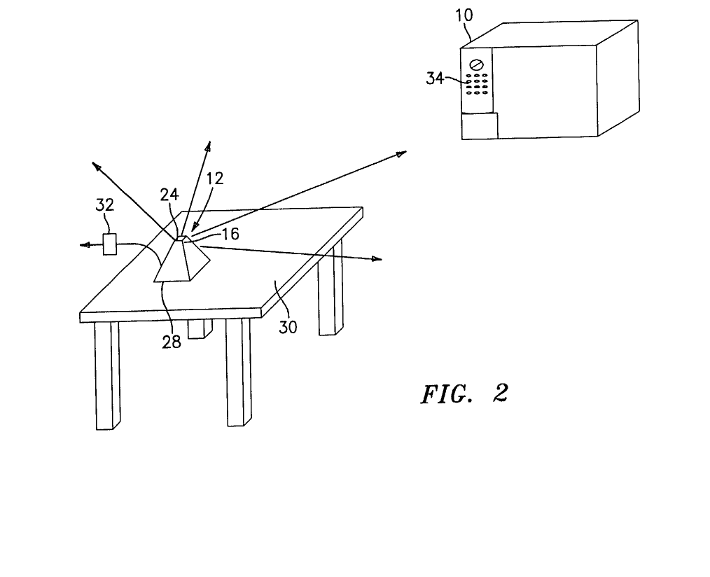

Turning now to FIG. 2, a preferred embodiment of use of a control module 12 in accordance with the present invention is illustrated. As shown, module 12 is provided in the form of a unit having a base 28 which is adapted for positioning on a flat surface such as a table 30. Control module 12 has an omni-directional microphone 16 and transmitter 24 which receive from and transmit to all directions, respectively. This configuration further expands the ability of a user to position module 12 in a particularly desirable location. Control module 12 in this embodiment has a housing containing the required elements of module 12 with microphone 16 and transmitter 24 positioned at the top of the housing for enhancing operation of same. Also as shown, module 12 in this embodiment is preferably adapted to receive a DC power supply through an AC-DC transformer 32 which can be plugged into a conventional DC power source or outlet. Such a power supply arrangement advantageously allows for module 12 to be left on for extended periods of time, whereby module 12 can continuously monitor for speech commands.

As shown in FIG. 2, module 12 can advantageously be used to control HVAC system 10 by a person located within speaking distance of module 12. This is particularly advantageous to a person who has lost mobility and/or manual dexterity, and would therefore be presented with difficulty in either utilizing controls 34 on system 10 itself, or in using conventional remote control devices which must be located, pointed properly at system 10, and then must have buttons and/or other manual controls properly manipulated.

Although FIG. 2 shows control module 12 having a substantially pyramid-shaped housing with microphone 16 and transmitter 24 mounted at a top thereof, other configurations could be used.

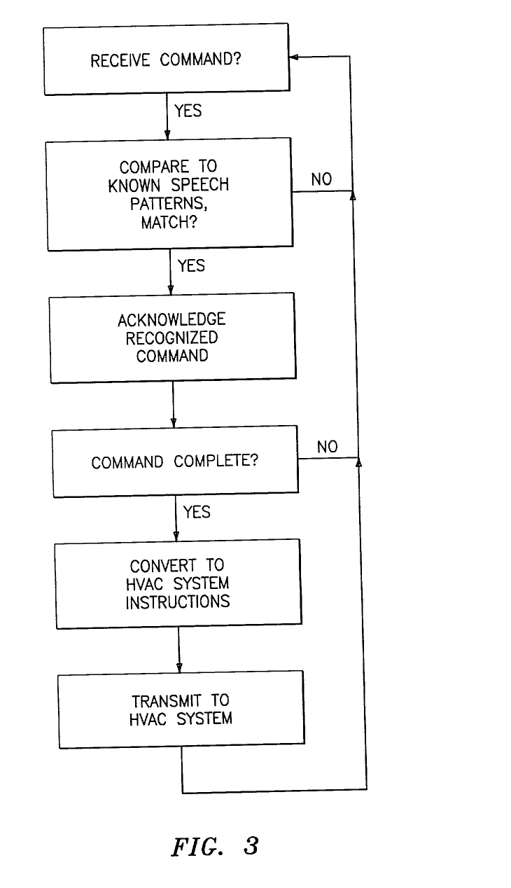

Turning to FIG. 3, a flowchart is provided for further illustrating operation of a control module 12 and system in accordance with one embodiment of the present invention. As shown, module 12 advantageously continuously monitors to determine whether a command has been received. When a speech command is received, module 12 compares the received command with known speech patterns to determine whether a match exists. If a match exists, receipt of the command is advantageously acknowledged, preferably by issuing a sound, preferably a speech signal, through speaker 26. If the received command does not match the stored known speech patterns, module 12 cycles back to receiving mode where received sounds are analyzed to determine matches with known speech patterns.

Module 12 may advantageously be programmed to listen for a key command which then allows other commands to be recognized. This advantageously reduces the likelihood of accidental issuance of commands to module 12, and/or the unauthorized issuance of commands, for example by young children.

After a received command is acknowledged, module 12 in accordance with the present invention analyzes the received and recognized command to determine whether a complete command has been received. If a complete command has not been received, module 12 cycles back to receive further portions of the command as shown in FIG. 3. If the command is a complete command, module 12 converts the received command into HVAC system instructions, or instructions for generating HVAC system instructions, and then transmits the HVAC system instructions to the system in question, for example through transmitter 24. Of course, following transmission of HVAC system instructions to system 10, module 12 cycles back to receiving mode where additional commands are awaited.

It should be appreciated that a control system and module have been provided according to the invention which provide greatly enhanced control options for controlling various HVAC systems. Such enhanced control options are particularly useful for all users, and especially for those who have difficulty using conventional control panels and/or conventional manually operated remote control devices.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A control system for a heating, ventilating or air conditioning (HVAC) system, comprising:
a remote command receiver for receiving HVAC system instructions for said HVAC system; and
a control module, comprising:
(i) a speech receiving member for receiving speech commands; and
(ii) a converter for converting said speech commands to HVAC system instructions; wherein said control module is communicated with said remote command receiver for conveying said HVAC system instructions from said control module to said remote command receiver.

2. The system of claim 1, wherein said control module further comprises a transmitter for transmitting said HVAC system instructions to said remote command receiver.

3. The system of claim 2, wherein said transmitter is a wireless transmitter, and said remote command receiver is a wireless receiver.

4. The system according to claim 2, wherein said transmitter and said remote command receiver are communicated by wireless communication selected from the group consisting of light-based communication, radio communication and combinations thereof.

5. The system according to claim 2, wherein said transmitter and said remote command receiver are communicated by light-based communications.

6. The system according to claim 2, wherein said transmitter and said remote command receiver are communicated by infrared communications.

7. The system of claim 1, wherein said control module further comprises an indicator member for identifying a received speech command.

8. The system of claim 7, wherein said control module further comprises a storage member for storing known speech patterns and corresponding indicators, and wherein said control module is adapted to compare said received speech command with said known speech patterns and to output an indicator corresponding to said received speech command.

9. The system of claim 8, wherein said indicator member is a speech simulator and said corresponding indicators are signals for generating speech.

10. The system according to claim 8, wherein said storage member also stores commands for generating HVAC system instructions corresponding to said known speech patterns whereby said control module acknowledges said received speech command and transmits corresponding HVAC system instructions.

11. The system of claim 1, wherein said control module further comprises a neural network adapted to train said control module for receiving personalized speech commands, and a storage member for storing personalized speech data and corresponding HVAC system instructions.

12. The system according to claim 1, wherein said control module further comprises a base member adapted for supporting said module on a flat surface.

13. The system according to claim 12, wherein said control module further comprises a plug member for connecting to an AC power source and an AC-DC transformer for supplying DC power to said control module.

14. The system according to claim 12, wherein said speech receiving member comprises a multi-directional microphone.

15. A control module for controlling a heating, ventilating or air conditioning (HVAC) system, comprising:
a speech receiving member for receiving speech commands;
a converter for converting said speech commands to HVAC system instructions; and
a transmitter for transmitting said HVAC system instructions to said HVAC system.

16. The apparatus of claim 15, wherein said transmitter is a wireless transmitter.

17. The apparatus of claim 15, wherein said transmitter is a transmitter selected from the group consisting of light-based transmitters and radio transmitters.

18. The apparatus of claim 15, wherein said transmitter is an infrared transmitter.

19. The apparatus of claim 15, further comprising an indicator member for identifying a received speech command.

20. The apparatus of claim 19, further comprising a storage member for storing known speech patterns and corresponding indicators, and wherein said converter is adapted to compare said received speech command with said known speech patterns and to output an indicator corresponding to said received speech command.

21. The apparatus of claim 20, wherein said indicator member is a speech simulator and said corresponding indicators are signals for generating speech.

22. The apparatus according to claim 21, wherein said storage member also stores commands for generating HVAC system instructions corresponding to said known speech patterns whereby said control unit acknowledges said received speech command and transmits corresponding HVAC system instructions.

23. The apparatus of claim 15, further comprising a neural network adapted to train said control module for receiving personalize speech commands, and a storage member for storing personalized speech data and corresponding HVAC system instructions.
